(19) United States
(12) Patent Application Publication
(10) Pub. No.: US 2008/0319138 A1
(43) Pub. Date: Dec. 25, 2008

(54) Initiator Systems for Use in Curing Unsaturated Resins, and Curable Compositions and Methods For Curing Them

(75) Inventor: Wenfeng Kuang, Baton Rouge, LA (US)

Correspondence Address: ALBEMARLE CORPORATION, 451 FLORIDA STREET, BATON ROUGE, LA, 70801-1765, US

(73) Assignee: ALBEMARLE CORPORATION, Baton Rouge, LA (US)

(21) Appl. No.: 12/096,121

(22) PCT Filed: Nov. 28, 2006
(86) PCT No.: PCT/US06/61344

§ 371 Date: Jun. 4, 2008

Related U.S. Application Data
(60) Provisional application No. 60/748,930, filed on Dec. 9, 2005.

(51) Int. Cl. C08F 8/40; C09K 3/00

(52) U.S. Cl. 525/340; 252/182.14

(57) ABSTRACT

Trivalent organic phosphorus compounds are used in combination with tertiary aromatic amine cure promoters in connection with peroxide initiated curing of curable unsaturated resins such as cross-linkable polyesters. The curing is conducted in the presence or absence of monomers having a terminal double bond. Curing rates have been improved by use of such combinations.

### BACKGROUND

The term “polyester”, as used herein, refers generally to the group of synthetic resins that are polycondensation products of dicarboxylic acids with dihydroxy alcohols. The term “unsaturated polyester resin”, as used herein, designates a linear-type alkyd resin possessing carbon-to-carbon double bond unsaturation in the polymer chain. These unsaturated polyesters may be crosslinked and thus cured by reaction with monomers such as styrene or diallylphthalate, usually in the presence of a peroxide to form insoluble and infusible resins without the formation of a by-product during the curing reaction. Other types of polymer resins are also known which include carbon-to-carbon double bond unsaturation in the polymer chain, and which can also be crosslinked and cured, such as urethane acrylates, epoxy acrylates, and the like. Accordingly as used herein including the claims, the term “curable unsaturated resin” whether used in the singular or plural denotes any polymeric resin that contains carbon-to-carbon double bond unsaturation that is curable or crosslinkable by use of a peroxide catalyst. Non-limiting examples of a curable unsaturated resin include, but are not limited to, at least one unsaturated polyester resin, at least one urethane acrylate, and at least one epoxy acrylate.

Because of their versatility and cost effectiveness, curable unsaturated resins possess broad commercial utility. Such utilities include, but are not limited to, low-pressure laminating; attractive and durable coatings for concrete, masonry, wood, plastic, wallboard, and metal; specialty resins targeted for synthetic marble, boat hulls, polymer concrete, mine-bolt resins, transfer molding, restorative dentistry, automotive body repair, and the like.

Tertiary aromatic amines are widely used as cure promoters or accelerators for curable unsaturated resins in the presence of peroxide initiators. Exemplary tertiary amines useful as cure promoters include, for example, N,N-dimethylaniline (DMA), N,N-diethylaniline (DEA), N-(2-hydroxyethyl)-N-methyl aniline, N-(2-hydroxyethyl)-N-ethyl aniline, N,N-bis-(2-hydroxyethyl)-m-toluidine, N-(2-hydroxyethyl)-N-[2-(2-hydroxyethoxy)ethylaniline, N,N-bis-(2-hydroxyethyl)-p-toluidine (HEPT), and N,N-dimethyl-p-toluidine (DMPT). However, cure rates for these types of compounds could be improved upon, especially at low temperatures e.g., 25° C. and below.

More recently, a class of tertiary aromatic amines exemplified by N-methyl-N-(2-hydroxyethyl)-p-toluidine (MHPT); N-ethyl-N-(2-hydroxyethyl)-p-toluidine (EHPT); and N-methyl-N-(2-hydroxypropyl)-p-toluidine (2HPMT) has been found to provide relatively fast cures at low temperatures of 25° C. and below. See for example U.S. Pat. Nos. 6,114,470 and 6,258,894.

Nevertheless, still further improvement in cure performance of tertiary aromatic amines in general and those of U.S. Pat. Nos. 6,114,470 and/or 6,258,894 in particular, would be of advantage, especially if desirable cure rates of curable unsaturated resins such as unsaturated polyester resins could be achieved at temperatures of about 20° C. or less, while retaining the capability of using elevated temperatures in situations where heating operations are readily conducted.

Another problem extant in the art relates to the fact that in peroxide curing systems various heavy metal salts are used in order to produce suitable curing times. As known in the art, such salts can cause severe color problems. For example, one commonly used metal salt is cobalt naphthenate which results in the cured polymer having an undesirable dark greenish color. Other transition metals are also known to produce adverse coloration in the cured products. In addition to color formation, a number of these metal salts tend to have undesirable toxicity characteristics. Also, some of these metal salts tend to cause premature oxidative degradation of the cured polymer products. Thus, another welcome contribution to the art would be a curing system that does not require use of such metal salts in order to achieve desirable curing times.

This invention is deemed to enable achievement of improvement in cure performance and to enable elimination of metal salt components from the curing mixtures.

### BRIEF SUMMARY OF THE INVENTION

In brief, the present invention improves the curing performance of tertiary aromatic amines by employing therewith at least one trivalent organic phosphorus compound as a co-promoter. The present invention also provides curable compositions and curing methods capable of accelerated rates of cure. In this connection, curing is generally understood to involve cross-linking and possibly polymerization as well. Accordingly, the term “curing” as used herein encompasses cross-linking and/or polymerization to whatever extent such mechanisms take place when unifying the components used in effecting curing pursuant to this invention. In addition, this invention enables elimination of undesirable metal salt components from curing systems.

Among various embodiments of this invention are:

A peroxide curing initiator composition which comprises at least one tertiary aromatic amine cure promoter, and at least one trivalent organic phosphorus compound co-promoter.

A curable composition comprising (i) at least one curable unsaturated resin, optionally in the presence of at least one monomer having a terminal double bond, (ii) at least one tertiary aromatic amine cure promoter, and (iii) at least one trivalent organic phosphorus compound; such composition being curable upon addition thereto of a peroxide initiator.

A method of curing polymeric resins, which method comprises introducing at least one peroxide initiator into a curable mixture comprised of (i) at least one curable unsaturated resin, optionally in the presence of at least one monomer having a terminal double bond, (ii) at least one tertiary aromatic amine cure promoter, and (iii) at least one trivalent organic phosphorus compound, and optionally heating the resultant mixture.

A method of curing polymeric resins, which method comprises forming a curable mixture comprised of (i) at least one curable unsaturated resin, optionally in the presence of at least one monomer having a terminal double bond, (ii) at least one tertiary aromatic amine cure promoter, and (iii) at least one trivalent organic phosphorus compound, and (iv) at least one peroxide initiator, and optionally heating the mixture.

A cured composition formed from components comprising (i) at least one curable unsaturated resin, optionally in the presence of at least one monomer having a terminal double bond, (ii) at least one tertiary aromatic amine cure promoter, (iii) at least one trivalent organic phosphorus compound; and (iv) at least one peroxide initiator.

Among the various advantages of this invention are that amounts of tertiary aromatic amines can, in some cases, be reduced, and that the residual phosphorus residues produced during the curing can provide protection against premature oxidative degradation.

These and other embodiments and features of the present invention will become apparent from the ensuing description and appended claims.

### FURTHER DETAILED DESCRIPTION OF THE INVENTION

### Tertiary Aromatic Amine Cure Promoter

A wide variety of tertiary aromatic amine cure promoters for use with peroxides, known and reported in the literature, can be used in the practice of this invention. Non-limiting examples of such compounds include N,N-dimethylaniline, N,N-diethylaniline, N-(2-hydroxyethyl)-N-methyl aniline, N-(2-hydroxyethyl)-N-ethyl aniline, N,N-bis-(2-hydroxyethyl)-m-toluidine, N-(2-hydroxyethyl)-N-[2-(2-hydroxyethoxy)ethylaniline, N,N-bis-(2-hydroxyethyl)-p-toluidine, and N,N-dimethyl-p-toluidine.

One group of preferred tertiary aromatic amine cure promoters is composed of N,N-dialkyl-p-toluidines wherein each alkyl group contains independently in the range of 1 to about 6 carbon atoms. Of such compounds N,N-diethyl-p-toluidine is a more preferred member of the group, with N,N-dimethyl-p-toluidine being an even more preferred member of this group.

Also preferred for use in this invention are tertiary aromatic amine cure promoters of Formula (I):

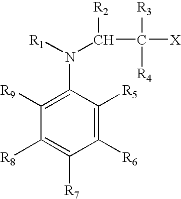

wherein:

R₁ is linear or branched C₁ to C₆ alkyl or C₃ to C₆ cycloalkyl;
R₂ is H, linear or branched C₁ to C₆ alkyl or C₃ to C₆ cycloalkyl, wherein said C₁ to C₆ alkyl or C₃ to C₆ cycloalkyl is optionally substituted at the C₁ or C₃ position, respectively, by X as defined below;
R₃ and R₄ are each independently selected from the group consisting of H, linear or branched C₁ to C₆ alkyl, and C₃ to C₆ cycloalkyl;
R₅, R₆, R₇, R₈, and R₉ are each independently selected from the group consisting of H, linear or branched C₁ to C₆ alkyl, C₃ to C₆ cycloalkyl, and C₁ to C₆ alkoxy; and
X is OH, OR₁, CN, OC(O)R₁, O[(CH₂)ₘ O]ₙ H or O[(CH₂)ₘ O]ₙ R₁, wherein m=1 to 6 and n=1 to 6, and wherein R₁ is as defined above.

As used herein, the term “C₁ to C₆ alkyl” refers to C₁ to C₆ linear or branched alkyl, such as methyl, ethyl, propyl, butyl, isopropyl, sec-butyl, and tert-butyl, butyl, pentyl, isopentyl, and hexyl. The term “cycloalkyl” as used herein refers to C₃ to C₆ cyclic alkyl, such as cyclopropyl, cyclobutyl, cyclopentyl, and cyclohexyl. The term “alkoxy” as used herein refers to C₁ to C₆ linear or branched oxygen-substituted alkyl, such as methoxy, ethoxy, propoxy, butoxy, isopropoxy, and t-butoxy.

More preferred for use in this invention are compounds of Formula (I) wherein:

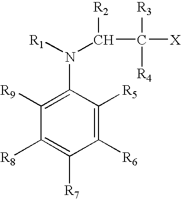

R₁ is methyl or ethyl;
R₂ is H or hydroxymethyl;
R₃ or R₄ are each independently selected from the group consisting of H, methyl and ethyl;
R₅, R₆, R₇, R₈, and R₉ are each independently selected from the group consisting of H and methyl; and
X is OH or O[(CH₂)ₘ O]ₙ H, wherein m=2 and n=1 to 6.
Exemplary compounds of Formula (I) in accordance with the invention include, but are not limited to, N-methyl-N-(2-hydroxyethyl)-p-toluidine (MHPT); N-ethyl-N-(2-hydroxyethyl)-p-toluidine (EHPT); and N-methyl-N-(2-hydroxypropyl)-p-toluidine (2HPMT).

The tertiary aromatic amine cure promoter compounds used in accordance with the invention can be used individually. However, mixtures thereof can also be used.

Methods for the synthesis of compounds of Formula (I) and methods of using them as cure promoters are set forth in U.S. Pat. Nos. 6,114,470 and 6,258,894. For example, alkylation of an appropriate N-alkyl-p-toluidine with a 1,2-alkylene oxide provides, for example, an N-alkyl-N-(2-hydroxyalkyl)-p-toluidine. Thus, MHPT can be prepared by adding a slight molar excess of ethylene oxide to N-methyl-p-toluidine and subjecting the mixture to conditions sufficient to ethoxylate the toluidine compound. The ethoxylation can be performed by methods known in the art.

The compounds of Formula (I) can also be synthesized by alkylation of an appropriate N-hydroxyalkyl-p-toluidine. For example, MHPT can be prepared by adding formaldehyde and hydrogen to a mixture of N-hydroxyethyl-p-toluidine and palladium on a carbon catalyst under appropriate temperature and pressure conditions, such as at 120° C. and 120 psig.

### Trivalent Organic Phosphorus Cure Co-Promoter

In the practice of this invention any of a variety of trivalent organic phosphorus compounds can be used as cure co-promoters. Such compounds include, but are not limited to, trihydrocarbyl phosphines (R)₃P, trihydrocarbyl phosphites (RO)₃P, trihydrocarbyl trithiolphosphites (RS)₃P, and hexaalkylphosphorus triamides [(R¹R²)N]₃P, wherein each R group is, independently, a hydrocarbyl group and R¹ and R² are, independently, alkyl groups. As is well-known in the art, hydrocarbyl groups are univalent groups made up of carbon and hydrogen atoms and are structured as if, theoretically, one hydrogen atom were removed from a hydrocarbon. Non-limiting examples of hydrocarbyl groups include alkyl; cycloalkyl; alkenyl; cycloalkenyl; alkynyl; aryl; aralkyl, a.k.a. arylalkyl such as benzyl; and analogous groups in which a ring of a cycloalkyl, cycloalkenyl, aryl, or aralkyl group is substituted by at least one additional hydrocarbyl group, e.g., alkylcycloalkyl; alkylcycloalkenyl; alkylaryl, a.k.a. alkaryl; alkylaralkyl; and analogs groups of this type.

The number of carbon atoms in the hydrocarbyl group is not deemed critical and thus can be in the hundreds or more, but usually as articles of commerce each hydrocarbyl group will typically be no more than about 24 carbon atoms. A few non-limiting examples of these trivalent organic phosphorus compounds include triethyl phosphine, triisopropyl phosphine, tributyl phosphine, tridecyl phosphine, triethyl phosphite, tributyl phosphite, trioctyl phosphite, tri-2-ethylhexyl phosphite, trioleyl phosphite, tricyclopentyl phosphite, tricyclohexyl phosphite, tri(4-methylcyclohexyl) phosphite, (cyclohexyl)di(methyl)phosphite, triphenyl phosphite, tri-o-tolyl phosphite, tri-m-tolyl phosphite, tri-p-tolyl phosphite, tritolyl phosphite (mixed isomers), (cresyl)di(phenyl) phosphite, di(cresyl)(phenyl) phosphite, tribenzyl phosphite, tri-(p-methylbenzyl) phosphite, tri-(2-phenethyl) phosphite, triethyl trithiolphosphite, tri(4-methylpentyl) trithiolphosphite, trihexyl trithiolphosphite, trilauryl trithiolphosphite, tricyclopentyl trithiolphosphite, tricycloheptyl trithiolphosphite, tri(3-methylcyclohexyl) trithiolphosphite, di(cyclohexyl)(methyl) trithiolphosphite, triphenyl trithiolphosphite, tri-m-tolyl trithiolphosphite, tritolyl trithiolphosphite (mixed isomers), (cresyl)di(phenyl) trithiolphosphite, di(cresyl)(phenyl) trithiolphosphite, tribenzyl trithiolphosphite, tribenzyl trithiolphosphite, tri-(p-methylbenzyl) trithiolphosphite, hexamethylphosphorus triamide, and hexaethylphosphorus triamide.

Methods of preparing such trivalent organic phosphorus compounds are known and reported in the literature. Many such compounds are available in the marketplace.

### Proportions Used

In the practice of this invention the relative proportions of the at least one tertiary aromatic amine cure promoter, and the at least one trivalent organic phosphorus compound co-promoter can vary depending upon the specific materials that are to be used or are being used, and the conditions under which they are to be used or are being used. Generally, however, the tertiary aromatic amine:trivalent organic phosphorus compound weight ratio will be in the range of about 0.01:1 to about 100:1, preferably in the range of about 0.1:1 to about 10:1, and more preferably in the range of about 0.2:1 to about 5:1.

The dosage levels of the tertiary aromatic amine and trivalent organic phosphorus compound used in forming the overall mixture of curable unsaturated resin(s), tertiary aromatic amine promoter(s), and trivalent organic phosphorus compound co-promoter(s) will typically be in the range of about 0.002 to about 10 wt %, preferably in the range of about 0.003 to about 5 wt %, more preferably in the range of about 0.01 to about 5 wt %, and still more preferably in the range of about 0.1 to about 0.5 wt % of tertiary aromatic amine promoter(s), and in the range of about 0.002 to about 10 wt %, preferably in the range of about 0.003 to about 5 wt %, more preferably in the range of about 0.01 to about 5 wt %, and still more preferably in the range of about 0.1 to about 0.5 wt % of trivalent organic phosphorus compound co-promoter(s), these weight percentages being based on the weight of the curable unsaturated resin(s).

In forming the overall mixture of curable unsaturated resin(s), tertiary aromatic amine promoter(s), and trivalent organic phosphorus compound co-promoter(s), these components can be mixed together in any order and added either individually or in any subcombination(s). It is preferred to used a preformed peroxide curing initiator composition of this invention which, as noted above, comprises at least one tertiary aromatic amine cure promoter, and at least one trivalent organic phosphorus compound co-promoter. Use of such a preformed composition in the blending minimizes the likelihood of blending errors and facilitates the blending operation.

Typically the peroxide initiator is introduced as a final component.

### Curable Unsaturated Resin

This invention is applicable to any polymeric resin that contains carbon-to-carbon double bond unsaturation and that is curable or crosslinkable by use of a peroxide catalyst. Non-limiting examples of curable unsaturated resins include, but are not limited to, one or a mixture of more than one unsaturated polyester resin, one or a mixture of more than one urethane acrylate, one or a mixture of more than one epoxy acrylate. Mixture of different types of such curable resins can also be cured pursuant to this invention.

Curable unsaturated polyester resins include conventional unsaturated polyester resins known in the art. Thus, the unsaturated polyesters may be obtained by reaction of approximately equivalent amounts of a polyvalent alcohol such as ethylene glycol, diethylene glycol, triethylene glycol, trimethylene glycol, propylene glycol, pentaerythritol, and other diols or polyols with an unsaturated dibasic carboxylic acid or carboxylic anhydride such as maleic acid, maleic anhydride, fumaric acid, itaconic acid, or citraconic acid. These unsaturated dibasic carboxylic acids or anhydrides are often used in combination with aromatic and/or saturated aliphatic dicarboxylic acids or the anhydrides derived therefrom, such as phthalic acid, phthalic anhydride, isophthalic acid, tetrachlorophthalic acid, malonic acid, adipic acid, sebacic acid, tartaric acid, and the like.

Curable unsaturated polyester resins containing vinyl groups or vinylidene groups may be obtained by polycondensation of alpha, beta-unsaturated monocarboxylic acids such as acrylic or methacrylic acid, with mono-, di- or polyhydric alcohols. Exemplary alcohols include methanol, ethanol, isopropanol, cyclohexanol, phenol, ethylene glycol, propylene glycol, 2,2-bis(4-hydroxyphenyl)propane, 2,2-bis(4-hydroxycyclohexyl)propane, 2,2-bis(4-beta-hydroxyethyloxy-phenyl)propane, pentaerythritol and dimers thereof, trimethol propane and a glycerol, and the complex diols or polyols. Unsaturated polyesters containing vinyl groups or vinylidene groups also may be obtained by reacting alpha, beta-unsaturated monocarboxylic acids with compounds containing epoxy groups, such as bisphenol A bis(glycidyl ether).

Further, the curable unsaturated polyester resins cured pursuant to this invention can be dissolved in monomers copolymerizable with the polyester, which monomers contain one or more carbon-to-carbon double bonds. Examples of such monomers are styrene, vinyl toluene, methylmethacrylate, ethyleneglycolmethacrylate, and various other known monomers, as are known to those skilled in the art. The preferred solutions for use in this invention are those which contain from about 70 to 50 percent by weight of unsaturated polyester and 30 to 50 percent by weight of copolymerizable monomer. Styrene is a preferred copolymerizable monomer for these curable unsaturated resin systems.

Another type curable unsaturated resins that can be cured pursuant to this invention include conventional polyurethane acrylate resins known in the art. The unsaturated polyurethane may be obtained by reaction of a polyisocyanate, such as toluene diisocyanate, diphenylmethane diisocyanate, hexamethylene diisocyanate, and the like, with an appropriate compound containing at least two active hydrogen atoms, such as a polyol or a polyamine. Exemplary polyols include ethylene glycol, diethylene glycol, triethylene glycol, trimethylene glycol, propylene glycol, pentaerythritol, and other diols or polyols. Urethane polymers may be used in the form of homopolymers or, more preferably, with various other monomers which can be copolymerized therewith. For example, urethane polymers can be prepared by reacting any of a variety of acrylic comonomers, such as acrylic and methacrylic acids, and their amides, esters, salts and corresponding nitriles, with the polyurethane resin. Particularly suitable comonomers for such polymers are methyl methacrylate, ethyl acrylate and acrylonitrile.

Still another exemplary type of curable unsaturated resins which can be cured pursuant to this invention include unsaturated epoxy resins known in the art. Unsaturated epoxy resins may be obtained by reaction of an epoxide group (resulting form the union of an oxygen atom with two other atoms, usually carbon), such as epichlorohydrin, oxidized polyolefins, for example ethylene oxide, with an aliphatic or aromatic alcohol such as bisphenol-A, glycerol, etc. As with curable unsaturated resins described above, the epoxy resins may be used in the form of homopolymers or copolymers with various other comonomers which can be reacted therewith, including various acrylic monomers, such as acrylic and methacrylic acids, and their amides, esters, salts and corresponding nitrites.

### Other Components

Other components can be used (A) in the peroxide curing initiator compositions of this invention, i.e., the compositions which comprise at least one tertiary aromatic amine cure promoter, and at least one trivalent organic phosphorus compound co-promoter; (B) in the crosslinkable compositions of this invention, i.e., the compositions which are curable upon addition thereto of a peroxide initiator and which comprise (i) at least one curable unsaturated resin, (ii) at least one tertiary aromatic amine cure promoter, and (iii) at least one trivalent organic phosphorus compound; and in the methods of this invention for curing polymeric resins.

Oxidation inhibitors are one such type of optional component for use in the compositions of this invention. A few non-limiting examples of preferred oxidation inhibitors include pentaerythritol tetrakis[3-(3,5-di-tert-butyl-4-hydroxyphenyl)propionate], 1,3,5-trimethyl-2,4,6-tris(3,5-di-tert-butyl-4-hydroxybenzyl)benzene, octadecyl-3-(3,5-di-tert-butyl-4-hydroxyphenyl)propionate], 1,3,5-tris(3,5-di-tert-butyl-4-hydroxybenzyl)-1,3,5-triazine-2,4,6(1H,3H,5H)trione, tris-(2,4-di-tert-butylphenyl)phosphite, bis(2,4-di-tert-butylphenol)pentaerythritol diphosphite, and similar antioxidants that are useful in polymeric materials. Many such antioxidants including those exemplified are available as articles of commerce.

Polymerization inhibitors, which typically are quinoline-type, nitroso-type, phenolic-type, or amine-type, are another type of optional component which can be used in the compositions of this invention. A few non-limiting examples of suitable polymerization inhibitors include hydroquinone, hydroquinone monomethyl ether, quinone, and p-tert-butyl catechol.

Among other components which can be used include: adhesion promoters which can be any of a variety of anionic, cationic, or nonionic substances such as for example acrylic acid, lauryl methacrylate, sunflower oil, tung oil, and alkyd resins; fillers, such as for example talc, clays, glass spheres or microballoons, wollastonite, kaolin, chalk, calcined kaolin, and polymeric particles; reinforcing agents, such as for example glass fibers, carbon fibers, metallic whiskers, polymer roving, potassium titanate fibers, and glass matting; and/or pigments or dyes.

While unnecessary, other curing agents such as metal salt curing agents such as, for example, transition metal salts such as organic salts of cobalt, zinc, manganese, iron, nickel, or titanium can be used, if desired. However since a number of such salts can cause problems such as color and toxicity problems, their use in the practice of this invention, while permissible, is preferably avoided.

### Peroxide Initiators

The polymerization or copolymerization peroxide initiators which can be used in the curable compositions of this invention, and in the methods of this invention for curing polymeric resins, are peroxides of the types commonly used for this purpose. Many are commercially available. Illustrative examples of suitable peroxides, include, but are not limited to, hydrogen peroxide, the ketone peroxides, such as acetylacetone peroxide, methylethylketone peroxide, cyclohexanone peroxide and methylisobutylketone peroxide; the diacyl peroxides, such as benzoyl peroxide, lauroyl peroxide, isobutyryl peroxide, acetyl peroxide, 2,4-dichlorobenzoyl peroxide, succinic acid peroxide, decanoyl peroxide, diisononanoyl peroxide; the peresters, such as tert-butyl peroxide-2-ethyl hexanoate; the perketals, such as 1,1-ditert-butylperoxy-3,3,5-trimethyl cyclohexane and dialkyl peroxides, such as 1,3-bis(tert-butylperoxyisopropyl)benzene. The diacyl peroxides, and particularly benzoyl peroxide, are the preferred initiators. The initiators are used in amounts known in the art, for example, for peroxide initiators, in the range of about 0.05 to about 10 wt % and preferably in the range of about 0.5 and about 10 wt %., based on the weight of the curable unsaturated resin.

The present invention will be further illustrated by the following non-limiting examples, in which in the Tables quantities are expressed in grams (g) and cure times are expressed as hours (hr) or minutes (min) and seconds (sec).

### EXAMPLES 1-3

In these experiments, three different phosphorus compounds were utilized in combination with N-methyl-N-(2-hydroxyethyl)-p-toluidine (MHPT) in the curing of a curable polyester resin from Bondo Corporation (stock no. 100219). The cures were conducted at 77° F. (25° C.) using methylethylketone peroxide (MEKP). In a control run, no co-promoter was used. The materials tested and results obtained are summarized in Table 1.

TABLE 1

| | Control | Example 1 | Example 2 | | Example 3 | |
|---|---|---|---|---|---|---|
| Resin | 9.7 g | 9.6 g | 9.6 | g | 9.6 | g |
| MHPT | 0.1 g | 0.1 g | 0.1 | g | 0.1 | g |
| MEKP | 0.2 g | 0.2 g | 0.2 | g | 0.2 | g |
| Triphenyl phosphine | | 0.1 g | | | | |
| Triphenyl phosphite | | | 0.1 | g | | |
| Triisopropyl | | | | | 0.1 | g |
| phosphite | | | | | | |
| Gel time | No cure | 10 min & 50 sec | 30 | min | 27 | min |

### EXAMPLE 4

The procedure of Example 3 was repeated using a lower concentration of triisopropyl phosphite with MHPT. In this instance, benzoyl peroxide (BPO) was used as the peroxide initiator in both Example 4 and the control run. The results are summarized in Table 2.

TABLE 2

| | Control | Example 4 |
|---|---|---|
| Resin | 9.95 g | 9.99 g |
| MHPT | 0.01 g | 0.01 g |
| BPO | 0.2 g | 0.2 g |
| Triisopropyl phosphite | — | 0.04 g |
| Gel time | 4 min & 42 sec | 3 min & 40 sec |

### EXAMPLES 5 and 6

The procedure of Example 4 was repeated using two different trivalent organic phosphorus compounds, along with a control run. In this instance, the phosphorus compounds used were hexamethylphosphorus triamide (HMPT) and trilauryl trithiolphosphite (TLTP), and the peroxide was methylethylketone peroxide (MEKP). The compositions tested and results obtained are summarized in Table 3.

TABLE 3

| | Control | Example 5 | | Example 6 |
|---|---|---|---|---|
| Resin | 9.88 g | 9.88 | g | 9.93 g |
| MHPT | 0.07 g | 0.07 | g | 0.07 g |
| MEKP | 0.2 g | 0.2 | g | 0.2 g |
| Hexa- | | 0.05 | g | |
| methylphosphorus | | | | |
| triamide | | | | |
| Trilauryl | | | | 0.05 g |
| trithiolphosphite | | | | |
| Gel time | No cure in 2 days | 5 | hr | 29 min & 14 sec |

It is to be understood that the ingredients referred to by chemical name or formula anywhere in the specification or claims hereof, whether referred to in the singular or plural, are identified as they exist prior to coming into contact with another substance referred to by chemical name or chemical type (e.g., another reactant, a solvent, a diluent, or etc.). It matters not what preliminary chemical changes, transformations and/or reactions, if any, take place in the resulting mixture or solution or reaction medium as such changes, transformations and/or reactions are the natural result of bringing the specified reactants and/or components together under the conditions called for pursuant to this disclosure. Thus the reactants and other materials are identified as ingredients to be brought together in connection with performing a desired chemical reaction or in forming a mixture to be used in conducting a desired reaction. Also, even though the claims hereinafter may refer to substances, components and/or ingredients in the present tense (“comprises”, “is”, etc.), the reference is to the substance or ingredient as it existed at the time just before it was first contacted, blended or mixed with one or more other substances or ingredients in accordance with the present disclosure. The fact that the substance or ingredient may have lost its original identity through a chemical reaction or transformation or complex formation or assumption of some other chemical form during the course of such contacting, blending or mixing operations, is thus wholly immaterial for an accurate understanding and appreciation of this disclosure and the claims thereof. Nor does reference to an ingredient by chemical name or formula exclude the possibility that during the desired reaction itself an ingredient becomes transformed to one or more transitory intermediates that actually enter into or otherwise participate in the reaction. In short, no representation is made or is to be inferred that the named ingredients must participate in the reaction while in their original chemical composition, structure or form.

Each and every patent or other publication or published document referred to in any portion of this specification is incorporated in toto into this disclosure by reference, as if fully set forth herein.

Except as may be expressly otherwise indicated, the article “a” or “an” if and as used herein is not intended to limit, and should not be construed as limiting, a claim to a single element to which the article refers. Rather, the article “a” or “an” if and as used herein is intended to cover one or more such elements, unless the text expressly indicates otherwise.

This invention is susceptible to considerable variation in its practice. Therefore the foregoing description is not intended to limit, and should not be construed as limiting, the invention to the particular exemplifications presented hereinabove.

1. A peroxide curing initiator composition which comprises at least one tertiary aromatic amine cure promoter, and at least one trivalent organic phosphorus compound.

2. A composition as in claim 1 wherein said at least one trivalent organic phosphorus compound is (a) at least one trihydrocarbylphosphine, (b) at least one trihydrocarbyl phosphite, (c) at least one trihydrocarbyl trithiolphosphite, (d) at least one hexaalkylphosphorus triamide, or (e) a mixture of any two or more of (a), (b), (c), and (d).

3. A composition as in claim 1 wherein said at least one tertiary aromatic amine cure promoter is a compound of the formula 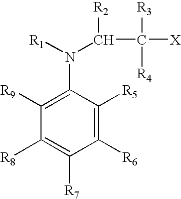
wherein:
R₁ is linear or branched C₁ to C₆ alkyl or C₃ to C₆ cycloalkyl;
R₂ is H, linear or branched C₁ to C₆ alkyl or C₃ to C₆ cycloalkyl, wherein said C₁ to C₆ alkyl or C₃ to C₆ cycloalkyl is optionally substituted at the C₁ or C₃ position, respectively, by X as defined below;
R₃ and R₄ are each independently selected from the group consisting of H, linear or branched C₁ to C₆ alkyl, and C₃ to C₆ cycloalkyl;
R₅, R₆, R₇, R₈, and R₉ are each independently selected from the group consisting of H, linear or branched C₁ to C₆ alkyl, C₃ to C₆ cycloalkyl, and C₁ to C₆ alkoxy; and
X is OH, OR₁, CN, OC(O)R₁, O[(CH₂)ₘO]ₙ H or O[(CH₂)ₘO]ₙ R₁, wherein m=1 to 6 and n=1 to 6; and wherein R₁ is as defined above.

4. A composition as in claim 3 wherein in said formula: 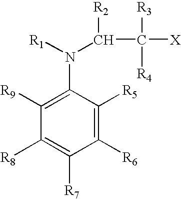
R₁ is methyl or ethyl;
R₂ is H or hydroxymethyl;
R₃ and R₄ are each independently selected from the group consisting of H, methyl and ethyl;
R₅, R₆, R₇, R₈, and R₉ are each independently selected from the group consisting of H and methyl; and
X is OH or O[(CH₂)ₘO]ₙH, wherein m=2 and n=1 to 6.

5. A composition as in claim 1 wherein said at least one tertiary aromatic amine cure promoter is at least one tertiary aromatic amine selected from N-methyl-N-(2-hydroxyethyl)-p-toluidine, N-ethyl-N-(2-hydroxyethyl)-p-toluidine, and N-methyl-N-(2-hydroxypropyl)-p-toluidine, and wherein said at least one trivalent organic phosphorus compound is at least one compound selected from triaryl phosphines, triaryl phosphites, trialkyl phosphites, trialkyl trithiolphosphites, and hexaalkylphosphorus triamides.

6. A composition as in claim 5 wherein said at least one tertiary aromatic amine cure promoter is N-methyl-N-(2-hydroxyethyl)-p-toluidine.

7. A curable composition comprising (i) at least one curable unsaturated resin, optionally in the presence of at least one monomer having a terminal double bond, (ii) at least one tertiary aromatic amine cure promoter, and (iii) at least one trivalent organic phosphorus compound; such composition being curable upon addition thereto of a peroxide initiator.

8. A composition as claim 7 wherein said at least one tertiary aromatic amine cure promoter is a compound of the formula 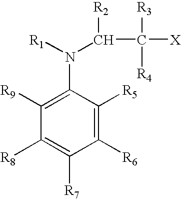
wherein:
R₁ is linear or branched C₁ to C₆ alkyl or C₃ to C₆ cycloalkyl;
R₂ is H, linear or branched C₁ to C₆ alkyl or C₃ to C₆ cycloalkyl, wherein said C₁ to C₆ alkyl or C₃ to C₆ cycloalkyl is optionally substituted at the C₁ or C₃ position, respectively, by X as defined below;
R₃ and R₄ are each independently selected from the group consisting of H, linear or branched C₁ to C₆ alkyl, and C₃ to C₆ cycloalkyl;
R₅, R₆, R₇, R₈, and R₉ are each independently selected from the group consisting of H, linear or branched C₁ to C₆ alkyl, C₃ to C₆ cycloalkyl, and C₁ to C₆ alkoxy; and
X is OH, OR₁, CN, OC(O)R₁, O[(CH₂)ₘO]ₙ H or O[(CH₂)ₘO]ₙ R₁, wherein m=1 to 6 and n=1 to 6, and wherein R₁ is as defined above.

9. A composition as in claim 8 wherein in said formula: 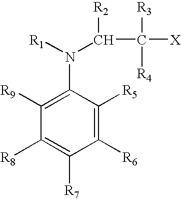
R₁ is methyl or ethyl;
R₂ is H or hydroxymethyl;
R₃ and R₄ are each independently selected from the group consisting of H, methyl and ethyl;
R₅, R₆, R₇, R₈, and R₉ are each independently selected from the group consisting of H and methyl; and
X is OH or O[(CH₂)ₘO]ₙH, wherein m=2 and n=1 to 6.

10. A composition as in claim 8 wherein said at least one tertiary aromatic amine cure promoter is at least one tertiary aromatic amine selected from N-methyl-N-(2-hydroxyethyl)-p-toluidine, N-ethyl-N-(2-hydroxyethyl)-p-toluidine, and N-methyl-N-(2-hydroxypropyl)-p-toluidine, and wherein said at least one trivalent organic phosphorus compound is at least one compound selected from triaryl phosphines, triaryl phosphites, trialkyl phosphites, trialkyl trithiolphosphites, and hexaalkylphosphorus triamides.

11. A composition as in claim 10 wherein said at least one tertiary aromatic amine cure promoter is N-methyl-N-(2-hydroxyethyl)-p-toluidine.

12. A composition as in claim 7 wherein said curable composition includes at least one monomer having a terminal double bond.

13. A composition as in claim 7 wherein said curable composition is devoid of any monomer having a terminal double bond.

14. A method of curing polymeric resins, which method comprises introducing at least one peroxide initiator into a curable mixture comprised of (i) at least one curable unsaturated resin, optionally in the presence of at least one monomer having a terminal double bond, (ii) at least one tertiary aromatic amine cure promoter, and (iii) at least one trivalent organic phosphorus compound, and optionally heating the resultant mixture.

15. A method as in claim 14 wherein said at least one trivalent organic phosphorus compound is at least one trihydrocarbylphosphine, at least one trihydrocarbyl phosphite, at least one trihydrocarbyl trithiolphosphite, or at least one hexaalkylphosphorus triamide.

16. A method as in claim 14 wherein said at least one tertiary aromatic amine cure promoter is a compound of the formula 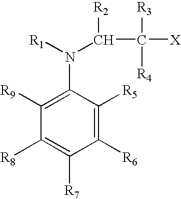
wherein:
R₁ is linear or branched C₁ to C₆ alkyl or C₃ to C₆ cycloalkyl;
R₂ is H, linear or branched C₁ to C₆ alkyl or C₃ to C₆ cycloalkyl, wherein said C₁ to C₆ alkyl or C₃ to C₆ cycloalkyl is optionally substituted at the C₁ or C₃ position, respectively, by X as defined below;
R₃ and R₄ are each independently selected from the group consisting of H, linear or branched C₁ to C₆ alkyl, and C₃ to C₆ cycloalkyl;
R₅, R₆, R₇, R₈, and R₉ are each independently selected from the group consisting of H, linear or branched C₁ to C₆ alkyl, C₃ to C₆ cycloalkyl, and C₁ to C₆ alkoxy; and
X is OH, OR₁, CN, OC(O)R₁, O[(CH₂)ₘO]ₙ H or O[(CH₂)ₘO]ₙ R₁, wherein m=1 to 6 and n=1 to 6, and wherein R₁ is as defined above.

17. A composition as in claim 16 wherein in said formula: 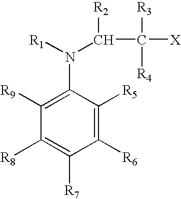
R₁ is methyl or ethyl;
R₂ is H or hydroxymethyl;
R₃ and R₄ are each independently selected from the group consisting of H, methyl and ethyl;
R₅, R₆, R₇, R₈, and R₉ are each independently selected from the group consisting of H and methyl; and
X is OH or O[(CH₂)ₘO]ₙH, wherein m=2 and n=1 to 6.

18. A method as in claim 14 wherein said curable mixture includes at least one monomer having a terminal double bond.

19. A method as in claim 14 wherein said curable mixture is devoid of any monomer having a terminal double bond.

20. A method of curing polymeric resins, which method comprises forming a curable mixture comprised of (i) at least one curable unsaturated resin, optionally in the presence of at least one monomer having a terminal double bond, (ii) at least one tertiary aromatic amine cure promoter, and (iii) at least one trivalent organic phosphorus compound, and (iv) at least one peroxide initiator, and optionally heating the mixture.

21. A method as in claim 20 wherein said at least one trivalent organic phosphorus compound is at least one trihydrocarbylphosphine, at least one trihydrocarbyl phosphite, at least one trihydrocarbyl trithiolphosphite, or at least one hexaalkylphosphorus triamide.

22. A method as in claim 20 wherein said at least one tertiary aromatic amine cure promoter is a compound of the formula 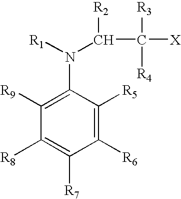
wherein:
R₁ is linear or branched C₁ to C₆ alkyl or C₃ to C₆ cycloalkyl;
R₂ is H, linear or branched C₁ to C₆ alkyl or C₃ to C₆ cycloalkyl, wherein said C₁ to C₆ alkyl or C₃ to C₆ cycloalkyl is optionally substituted at the C₁ or C₃ position, respectively, by X as defined below;
R₃ and R₄ are each independently selected from the group consisting of H, linear or branched C₁ to C₆ alkyl, and C₃ to C₆ cycloalkyl;
R₅, R₆, R₇, R₈, and R₉ are each independently selected from the group consisting of H, linear or branched C₁ to C₆ alkyl, C₃ to C₆ cycloalkyl, and C₁ to C₆ alkoxy; and
X is OH, OR₁, CN, OC(O)R₁, O[(CH₂)ₘO]_{.n} H or O[(CH₂)ₘO]ₙ R₁, wherein m=1 to 6 and n=1 to 6, and wherein R₁ is as defined above.

23. A composition as in claim 20 wherein in said formula: 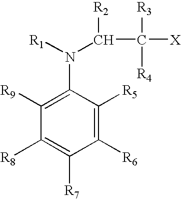
R₁ is methyl or ethyl;
R₂ is H or hydroxymethyl;
R₃ and R₄ are each independently selected from the group consisting of H, methyl and ethyl;
R₅, R₆, R₇, R₈, and R₉ are each independently selected from the group consisting of H and methyl; and
X is OH or O[(CH₂)ₘO]ₙH, wherein m=2 and n=1 to 6.

24. A method as in claim 20 wherein said curable mixture includes at least one monomer having a terminal double bond.

25. A method as in claim 20 wherein said curable mixture is devoid any monomer having a terminal double bond.

26. A cured composition formed from components comprising (i) at least one curable unsaturated resin, (ii) at least one tertiary aromatic amine cure promoter, (iii) at least one trivalent organic phosphorus compound; and (iv) at least one peroxide initiator, wherein optionally (i) is cured in the presence of at least one monomer having a terminal double bond.

27. A composition as in claim 26 wherein said at least one tertiary aromatic amine cure promoter is a compound of the formula 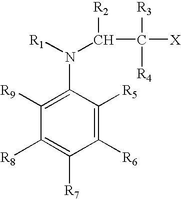
wherein:
R₁ is linear or branched C₁ to C₆ alkyl or C₃ to C₆ cycloalkyl;
R₂ is H, linear or branched C₁ to C₆ alkyl or C₃ to C₆ cycloalkyl, wherein said C₁ to C₆ alkyl or C₃ to C₆ cycloalkyl is optionally substituted at the C₁ or C₃ position, respectively, by X as defined below;
R₃ and R₄ are each independently selected from the group consisting of H, linear or branched C₁ to C₆ alkyl, and C₃ to C₆ cycloalkyl;
R₅, R₆, R₇, R₈, and R₉ are each independently selected from the group consisting of H, linear or branched C₁ to C₆ alkyl, C₃ to C₆ cycloalkyl, and C₁ to C₆ alkoxy; and
X is OH, OR₁, CN, OC(O)R₁, O[(CH₂)ₘO]ₙ H or O[(CH₂)ₘO]ₙ R₁, wherein m=1 to 6 and n=1 to 6, and wherein R₁ is as defined above.

28. A composition as in claim 27 wherein in said formula: 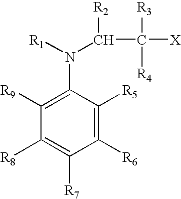
R₁ is methyl or ethyl;
R₂ is H or hydroxymethyl;
R₃ and R₄ are each independently selected from the group consisting of H, methyl and ethyl;
R₅, R₆, R₇, R₈, and R₉ are each independently selected from the group consisting of H and methyl; and
X is OH or O[(CH₂)ₘO]ₙH, wherein m=2 and n=1 to 6.

29. A composition as in claim 27 wherein said at least one tertiary aromatic amine cure promoter is at least one tertiary aromatic amine selected from N-methyl-N-(2-hydroxyethyl)-p-toluidine, N-ethyl-N-(2-hydroxyethyl)-p-toluidine, and N-methyl-N-(2-hydroxypropyl)-p-toluidine, and wherein said at least one trivalent organic phosphorus compound is at least one compound selected from triaryl phosphines, triaryl phosphites, trialkyl phosphites, trialkyl trithiolphosphites, and hexaalkylphosphorus triamides.

30. A composition as in claim 29 wherein said at least one tertiary aromatic amine cure promoter is N-methyl-N-(2-hydroxyethyl)-p-toluidine.

31. A composition as in claim 26 wherein said composition is cured with said at least one tertiary aromatic amine being in admixture with at least one monomer having a terminal double bond.

32. A composition as in claim 26 wherein said composition is cured in the absence of any monomer having a terminal double bond.
